(19) United States
(12) Patent Application Publication
(10) Pub. No.: US 2002/0152129 A1
(43) Pub. Date: Oct. 17, 2002

(54) Method for networking online apparel purchasing and offline apparel cleaning

(76) Inventor: Hyung C. Bae, Torrance, CA (US)

Correspondence Address: JOHN K. PARK, PARK & SUTTON LLP, 3255 WILSHIRE BLVD., SUITE 1110, LOS ANGELES, CA, 90010, US

(21) Appl. No.: 09/835,766

(22) Filed: Apr. 16, 2001

(51) Int. Cl. G06F 17/60

(52) U.S. Cl. 705/26

(57) ABSTRACT

A method for networking an online apparel purchasing and an offline apparel cleaning is disclosed. The method comprises the steps of: establishing a merchant website administered by an online merchant, wherein the merchant website enables an online shopper to make an online purchase; said online shopper ordering one or more apparels from the merchant website; said online merchant dispatching the ordered apparels to a cleaner; said cleaner pressing the apparels dispatched from the online merchant; and said cleaner dispatching the pressed apparels to the online shopper.

### BACKGROUND OF THE INVENTION

The invention relates to a method that facilitates the networking of apparel purchasing and apparel cleaning. More particularly, the present invention relates to a method for ideally linking an online apparel shopping and an offline cleaning by allowing an online merchant to directly ship the ordered apparel to a cleaner so that the cleaner delivers the washed and ironed apparel to the online shopper.

As the busy life style prevails, a cleaning shop or laundry becomes one of the most familiar places to visit in most countries. Further, when it comes to new clothing, an increasing number of people make the newly purchased apparel pressed by the cleaner out of the shopping bag.

Considering the trend that many shoppers browse through the internet for online shopping, more and more shoppers lose their meaning in online shopping, because many believe that they have to inevitably rely on offline cleaning process. That is, a substantial number of online apparel shoppers want the newly purchased apparels to be cleaned and ironed before they put them on.

### SUMMARY OF THE INVENTION

Therefore, it is an object of the invention is to provide a method for networking an online apparel purchasing and an online apparel cleaning to realize a substantial convenience for an online shopper. Another object of the invention is to provide a win-win model in which to allow each of an online shopper, an online merchant and a cleaner to be beneficiary.

To achieve the above-described objects, a method for networking an online apparel purchasing and an offline apparel cleaning comprises the steps of: establishing a merchant website administered by an online merchant, wherein the merchant website enables an online shopper to make an online purchase; said online shopper ordering one or more apparels from the merchant website; said online merchant dispatching the ordered apparels to a cleaner; said cleaner pressing the apparels dispatched from the online merchant; and said cleaner dispatching the pressed apparels to the online shopper.

In an embodiment, the method comprises the steps of: establishing a first website administered by an online linker and a second website administered by an online merchant, wherein the first website is connected to the second website by a click-through link, wherein the second website is an online store selling apparels; directing an online shopper from the first website to the second website in accordance with the click-through link; said online merchant dispatching one or more apparels ordered through the second website by the online shopper to a cleaner; and said cleaner pressing the apparels from the online merchant; and said cleaner dispatching the pressed apparels to the online shopper.

Further, in another embodiment, a method for networking an apparel purchasing with an apparel cleaning by use of a merchant server, a cleaner server, and a merchant agent server, comprising the steps of: establishing an online merchant module in the merchant server, an online cleaner module in the cleaner server, and a merchant agent module in the agent server; said respective modules cryptographically communicating with each other via an online merchant interface supervised by an online merchant, a cleaner interface supervised by a cleaner, and a merchant agent interface supervised by a merchant agent, wherein said respective interfaces are correspondingly coupled to said respective modules through a network, wherein an online shopper interface administered by an online shopper is linked to the network; said merchant agent interface providing a click-through link from a first website supervised by the merchant agent module to a second website supervised by the online merchant module; said online merchant dispatching to the cleaner one or more apparels ordered on the second website for the apparel purchasing and cleaning by the online shopper, in accordance with an order information on the online merchant interface linked to the second website; and said cleaner pressing the apparels dispatched from the online merchant and dispatching the pressed apparels to the online shopper by either the cleaner's delivery or the online shopper's pickup.

The present invention are advantageous in that: (1) the networking method allows an online apparel shopper to easily include the apparel cleaning service while ordering the desired apparels from the online merchant, whereby the online shopper can make the ordered and cleaned apparels delivered from the nearest cleaner, thereby maximizing convenience of online apparel shoppers; (2) online transaction benefits or advantages according to the present invention are partaken among the online merchant and the online shopper including the merchant agent providing the click-through link under mutual satisfaction, thereby accelerating online transitions while further breeding related internet businesses; and (3) the networking method of online apparel purchasing and offline apparel cleaning according to the present invention optimally combines the internet shopping and the conventional offline cleaning service under a win-win strategy from which the online merchant and the cleaner maximize their respective profits and the online shopper maximizes its convenience.

Although the present invention is briefly summarized, the fuller understanding of the invention can be obtained by the following drawings, detailed description and appended claims.

### BRIEF DESCIPTION OF THE DRAWINGS

These and other features, aspects and advantages of the present invention will become better understood with reference to the accompanying drawings, wherein:

FIG. 1 is a diagram showing a mechanism according to an embodiment of the present invention;

FIG. 2 is a diagram showing a mechanism according to another embodiment of the present invention;

FIG. 3 is a diagram showing a merchant module according to the present invention; and

FIG. 4 is a flowchart showing respective steps of the mechanism according to the present invention.

### DETAILED DESCRIPTION OF THE PREFERRED EMBODIMENTS

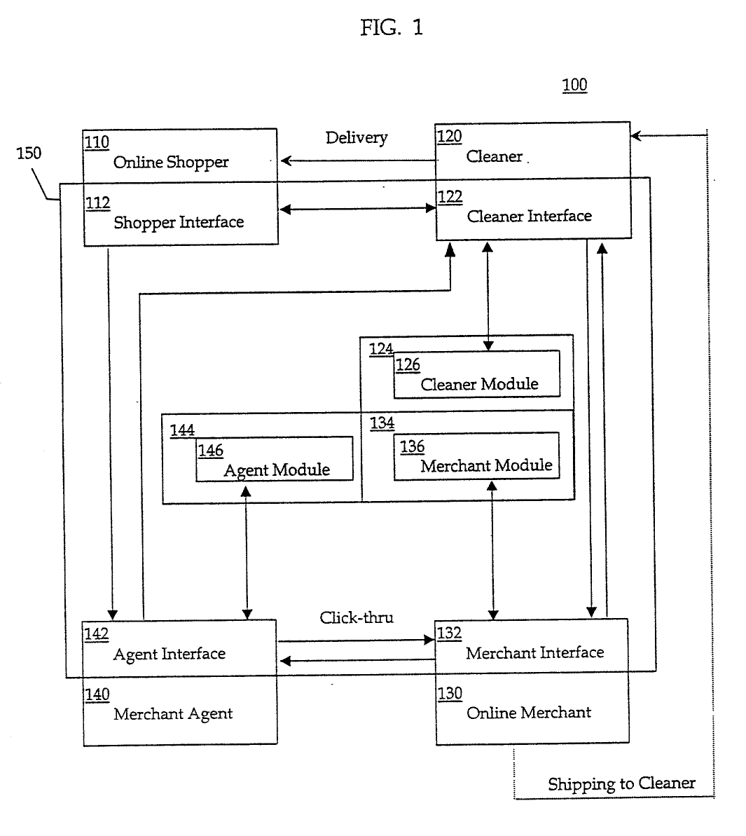

As shown in FIG. 1, the mechanism of the invention is incorporated in a combined environment of online and offline. As shown therein, the system 100 for implementing the networking method of an online apparel purchasing and an offline apparel cleaning includes an online shopper 110, a cleaner 120, an online merchant 130 and a merchant agent 140.

The online shopper 110 gets access to a network 150 through an online shopper interface 112 which may be a computer having a modem. The network 150 can be either a wide area network or the internet. The respective interfaces 122, 132, 142 of the cleaner 120, the online merchant 130 and the merchant agent 140 are connected to the network 150.

A cleaner server 124 within the network 150 contains a cleaner module 126, a merchant server 134 within the network 150 includes a merchant module 136, and a merchant agent module 144 within the network is provided with a merchant agent module 144. In this construction, each of the online shopper 110, the cleaner 120, the merchant 130 and the merchant agent 140 controls a corresponding one of the interfaces 112, 122, 132, 142 for respective purposes under cryptographical security.

Here, the cleaner module 126 is cryptographically controlled by the cleaner 120 via the interface 122, the merchant module 136 is cryptographically managed by the merchant via the merchant interface 132, and the merchant agent module 146 is cryptographically administered by the merchant agent 140 via the agent interface 142.

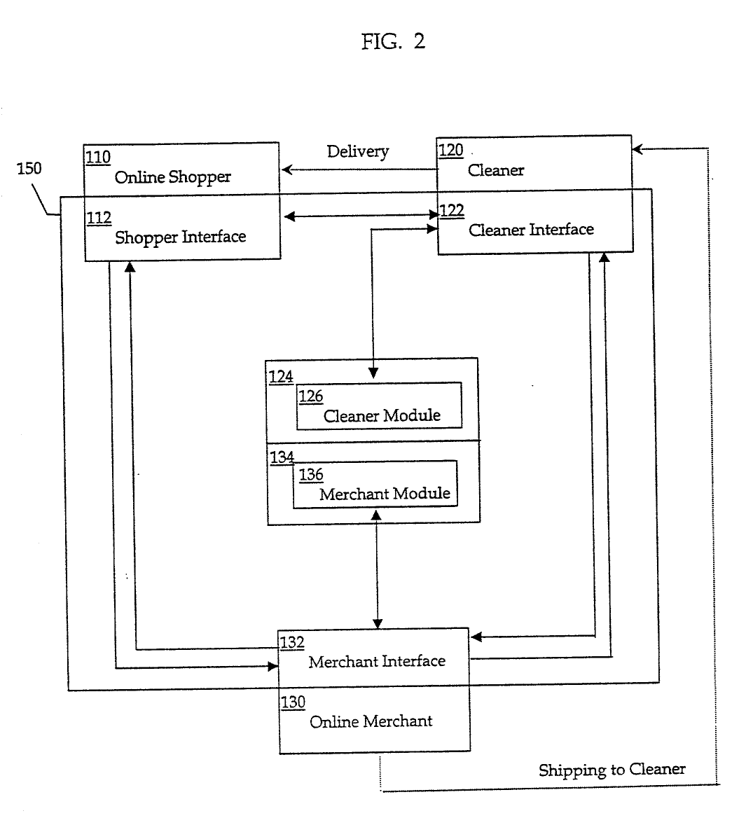

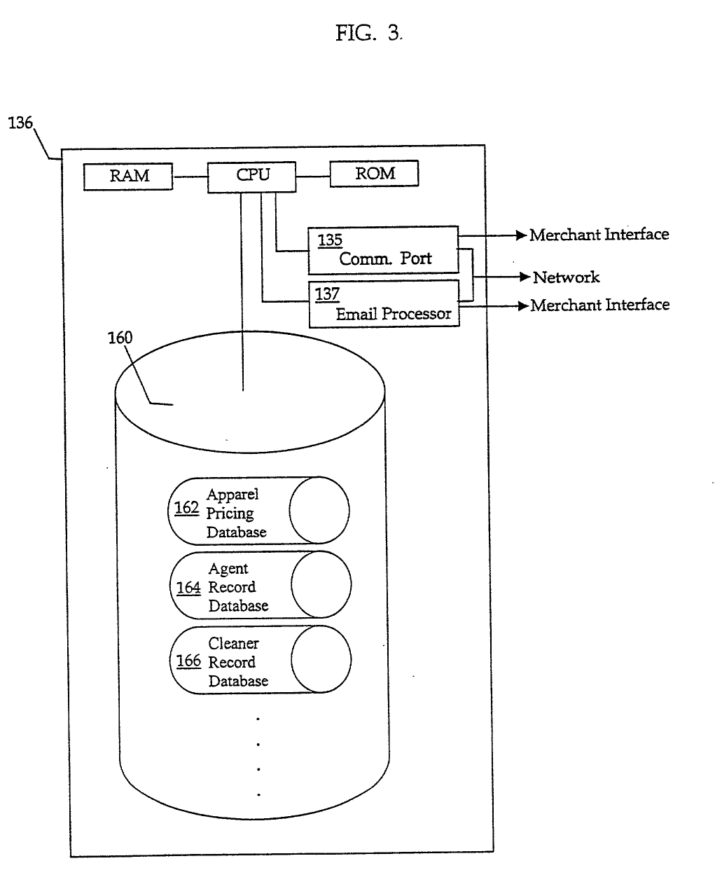

Referring to FIG. 2 showing a first embodiment of the mechanism according to the present invention, the method for networking an online apparel purchasing and an offline apparel cleaning comprises first to fifth steps, wherein the first step is to establish a merchant website administered by the online merchant 130, wherein the merchant website enables the online shopper 110 to make an online purchase. The merchant website may work on the merchant interface 132 under the control of the merchant module 136. At the second step, the online shopper 110 orders one or more apparels (not shown) from the merchant website. According to the third step, the online merchant 130 dispatches the ordered apparels to the cleaner 120. The subsequent fourth step is to allow the cleaner 120 to press the apparels dispatched from the online merchant 130. Eventually, at the fifth step, the cleaner 120 dispatches the pressed apparels to the online shopper 110.

In a preferred version, the dispatching of the pressed apparels from the cleaner 120 to the online shopper 110 is selectively implemented either by the cleaner's delivery or by the online shopper's pickup. Also, the merchant website may include a selectable apparel list, a selectable cleaner list, and a payment determiner on the screen menu thereof, wherein the payment determiner is provided to cryptographically determine a credit card payment.

For a better performance, the second step may include a substep of the online shopper 110 choosing one or more apparels for purchase and selecting a cleaner 120 for pressing the chosen apparels, respectively from the merchant website, and another substep of the online shopper 110 making an online payment for the chosen apparels and for the apparels cleaning at the selected cleaner 120, respectively from the merchant website.

Also, the fifth step may be followed by a step of the cleaner 120 receiving a cleaning charge from the online shopper 110. Selectively, the fifth step may be followed by a step of the cleaner 120 sending to the online merchant 130 a confirmation of the pressed apparel receipt by the online shopper 110, and another step of the online merchant 130 crediting a cleaning charge to an account of the cleaner 120.

Meanwhile, the fourth step may include a first substep for washing the apparels from the online merchant 130, a second substep of drying the washed apparels, and a third substep of ironing the dried apparels. Here, the third substep may be followed by a step of bagging the ironed apparels either on hanger or in box. Hemming the apparels when required can be also a substep option for the fourth step.

As shown back in FIG. 1, a second embodiment of the present invention includes the online apparel agent 140 for the networking mechanism. Specifically, the method for networking an online purchasing and an offline cleaning according to the second embodiment comprises a first step of establishing a first website administered by the online linker 140 and a second website administered by the online merchant 130, wherein the first website is connected to the second website by a click-through link, and the second website is an online store selling apparels. Here, the first website may be the merchant agent interface 142 controlled by the merchant agent module 146 and the second website may be the merchant interface 132 controlled by the merchant module 136. The first step is followed by a second step of directing the online shopper 110 from the first website of the online linker 140 to the second website of the online merchant 130 in accordance with the click-through link. A third step is to allow the online merchant 130 to dispatch one or more apparels ordered through the second website of the merchant 130 by the online shopper 110 to the cleaner 120. The third step is sequentially followed by a fourth step of the cleaner 120 pressing the apparels from the online merchant 130, and a fifth step of the cleaner 120 dispatching the pressed apparels to the online shopper 110.

In a third embodiment of the present invention, a method for networking an apparel purchasing with an apparel cleaning by use of the merchant server 134, the cleaner server 124, and the merchant agent server 144, comprises a first step of establishing the online merchant module 136 in the merchant server 134, the online cleaner module 126 in the cleaner server 124, and the merchant agent module 146 in the agent server 144. The first step is followed by a second step of the respective modules 126, 136, 146 cryptographically communicating with each other via the online merchant interface 132 supervised by the online merchant 130, the cleaner interface 122 supervised by the cleaner 120, and the merchant agent interface 142 supervised by the merchant agent 140 so that the respective interfaces 122, 132, 142 are correspondingly coupled to the respective 126, 136, 146 modules through the network 150. Here, the online shopper interface 112 administered by the online shopper 110 is also linked to the network.

The second step in the third embodiment is followed by the third step of the merchant agent interface 142 providing a click-through link from the first website supervised by the merchant agent module 146 to the second website supervised by the online merchant module 136. At the fourth step, the online merchant 130 dispatches to the cleaner 120 one or more apparels ordered on the second website for the apparel purchasing and cleaning by the online shopper 110, in accordance with an order information on the online merchant interface 132 linked to the second website. The subsequent fifth step is to allow the cleaner 120 to press the apparels dispatched from the online merchant 130 and to dispatch the pressed apparels to the online shopper 110 by either the cleaner's delivery or the online shopper's pickup.

Alternately, there may be provided between the third step and the fourth step of the third embodiment a step of enabling the shopper 110 to choose one or more apparels for purchase and selecting a cleaner 110 for pressing the chosen apparels, respectively from the second website, and another step of enabling the shopper 110 to make an online payment for the chosen apparels and for the apparels cleaning at the selected cleaner 110, respectively from the second website.

In FIGS. 3-5, respective modules 126, 136, 146 are described for communication capacity in the network 150. As shown in FIG. 3, the merchant module 136 includes a processor CPU, memories RAM, ROM each coupled to CPU, and a data storage 160 coupled to CPU. A communication port 135 open to the network 150 and provided in the merchant module 136 serves to link CPU and the merchant interface 132 therebetween. Also, an email processor 137 open to the network 150 and provided in the merchant module 136 is coupled to an email storage 139 in the merchant interface 132. The date storage 160 may include an apparel pricing database 162, an agent record database 164, a cleaner record database 166. Selectively, the cleaner module 126 and the apparel agent module 146 may be each formed in a manner that facilitates the communication among the participating parties to implement the networking of apparel purchasing and cleaning.

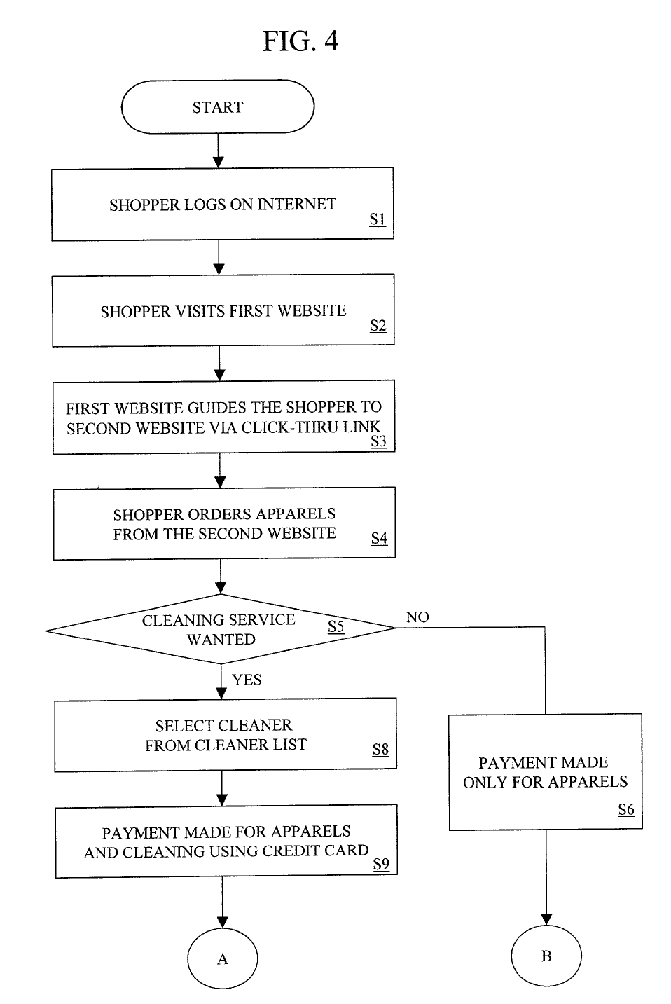

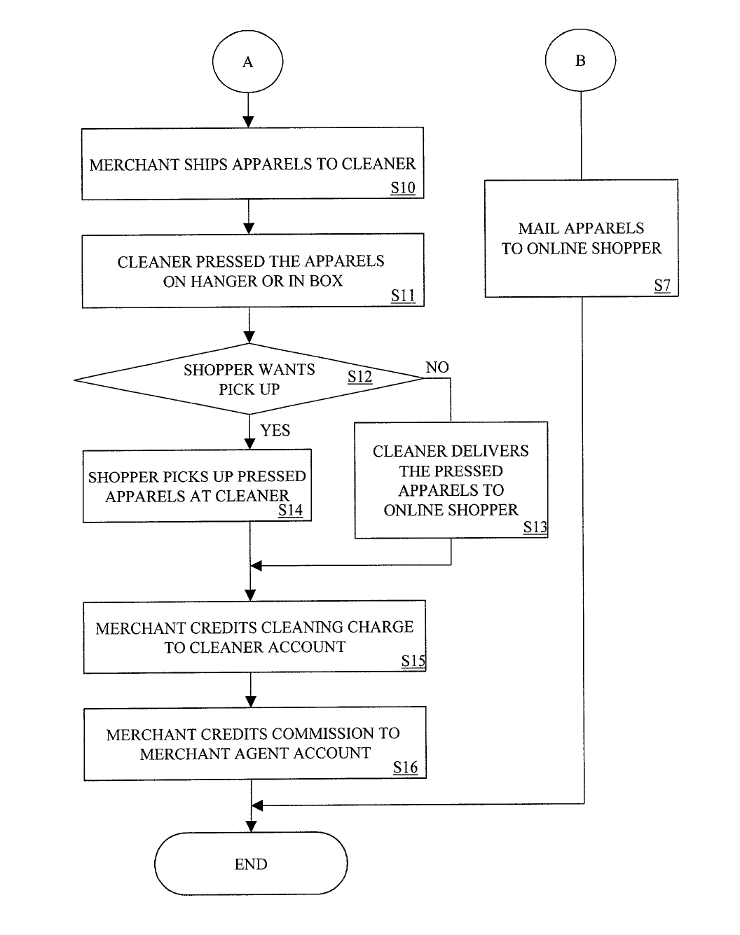

With reference to FIG. 4, the networking system for implementing the present invention will now be described. Once the online shopper 110 logs on the network 150 through a computer serving as the online shopper (S1), the shopper 110 may visit or run across a first website (S2) that maintains a link to a second website. When interested, the online shopper may click the link and be guided to the second website either by an on-site link or by a click-through link (S3). Here, the second website is an online store selling apparels.

When the online shopper orders (S4) apparels from the second website managed by the online merchant 130, the shopper decides whether to include a cleaning service for the ordered apparels (S5). If the shopper does not include the cleaning service, the payment is only made for the ordered garments (S6) and the ordered apparels will be mailed to the online shopper (S7).

If the online shopper wants a cleaning service, the shopper chooses a cleaner from the cleaner list on the second website, that is, on the online merchant website (S8). At this time, the payment will include the apparels and their cleaning (S9). When the payment is confirmed by the merchant, the ordered apparels will be shipped to the cleaner designated by the shopper (S10). The cleaner washes, dries and irons the shipped-in apparels on hanger or in box (S11). The cleaner checks if the cleaned apparels will be dispatched by the shopper's pickup or by the cleaner's delivery to the shopper (S12). So either the cleaner may deliver the cleaned apparels to the online shopper (S13) or the shopper may directly pick up the cleaned apparels at the cleaner (S14). Unless the cleaning charge is included in the initial payment by the shopper, the cleaning charge will be directly paid by the shopper to the cleaner in return for the receipt of the cleaned apparels.

When the cleaning charge is included in the initial payment by the shopper on the merchant website, the online merchant will credit the cleaning charge to the account of the cleaner (S15). In either case, if the shopper is directed through the first website or the linker's website to the merchant website, a commission will be credited to the account of the linker upon the confirmation of the apparel receipt by the shopper (S16).

As discussed above, the advantages of the present invention are numerous. First, the networking method allows an online apparel shopper to easily include the apparel cleaning service while ordering the desired apparels from the online merchant, whereby the online shopper can make the ordered and cleaned apparels delivered from the nearest cleaner, thereby maximizing convenience of online apparel shoppers.

Further, the online transaction benefits or advantages according to the present invention are partaken among the online merchant and the online shopper including the merchant agent providing the click-through link under mutual satisfaction, thereby accelerating online transitions while further breeding related internet businesses.

Still further, the networking method of online apparel purchasing and offline apparel cleaning according to the present invention optimally combines the internet shopping and the conventional offline cleaning service under a win-win strategy from which the online merchant and the cleaner maximize their respective profits and the online shopper maximizes its convenience.

Although the invention has been described in considerable detail, other versions are possible by converting the aforementioned construction. Therefore, the scope of the invention shall not be limited by the specification specified above and the appended claims.

What is claimed is:

1. A method for networking an online apparel purchasing and an offline apparel cleaning, comprising the steps of:
a) establishing a merchant website administered by an online merchant, wherein the merchant website enables an online shopper to make an online purchase;
b) said online shopper ordering one or more apparels from the merchant website;
c) said online merchant dispatching the ordered apparels to a cleaner;
d) said cleaner pressing the apparels dispatched from the online merchant; and
e) said cleaner dispatching the pressed apparels to the online shopper.

2. The method of claim 1, wherein the merchant website includes a selectable apparel list, a selectable cleaner list, and a payment determiner.

3. The method of claim 2, wherein the payment determiner cryptographically determines a credit card payment.

4. The method of claim 1, wherein the step b) comprises substeps of:
a) said online shopper choosing one or more apparels for purchase and selecting a cleaner for pressing the chosen apparels, respectively from the merchant website; and
b) said online shopper making an online payment for the chosen apparels and for the apparels cleaning at the selected cleaner, respectively from the merchant website.

5. The method of claim 1, further comprising, after the step e), a step of said cleaner receiving a cleaning charge from the online shopper.

6. The method of claim 1, further comprising, after the step e), the steps of:
a) said cleaner sending to the online merchant a confirmation of the pressed apparel receipt by the online shopper; and
b) said online merchant crediting a cleaning charge to an account of the apparel cleaner.

7. The method of claim 1, wherein the step d) comprises substeps of:
a) washing the apparels from the online merchant;
b) drying the washed apparels; and
c) ironing the dried apparels.

8. The method of claim 7, further comprising a step of bagging the ironed apparels either on hanger or in box.

9. The method of claim 1, wherein the dispatching of the pressed apparels to the online shopper is implemented either by the cleaner's delivery or by the online shopper's pickup.

10. A method for networking an online purchasing and an offline cleaning, comprising the steps of:
a) establishing a first website administered by an online linker and a second website administered by an online merchant, wherein the first website is connected to the second website by a click-through link, wherein the second website is an online store selling apparels;
b) directing an online shopper from the first website to the second website in accordance with the click-through link;
c) said online merchant dispatching one or more apparels ordered through the second website by the online shopper to a cleaner;
d) said cleaner pressing the apparels from the online merchant; and
e) said cleaner dispatching the pressed apparels to the online shopper.

11. The method of claim 10, wherein the second website includes a selectable apparel list, a selectable cleaner list, and a payment determiner.

12. The method of claim 11, wherein the payment determiner cryptographically determines a credit card payment.

13. The method of claim 10, further comprising, between the step b) and the step c), the steps of:
a) said online shopper choosing one or more apparels for purchase and select ng a cleaner for pressing the chosen apparels, respectively from the second website; and
b) said online shopper making an online payment for the chosen apparels and for the apparels cleaning at the selected cleaner, respectively from the second website.

14. The method of claim 10, wherein the step d) comprises substeps of:
a) washing the apparels from the online merchant;
b) drying the washed apparels; and
c) ironing the dried apparels.

15. The method of claim 14, further comprising a step of bagging the ironed apparels either on hanger or in box.

16. The method of claim 10, further comprising, after the step e), a step of said cleaner receiving a cleaning charge from the online shopper.

17. The method of claim 10, further comprising, after the step e), the steps of:
a) said cleaner sending to the online merchant a confirmation of the pressed apparel receipt by the online shopper;
b) said online merchant crediting a cleaning charge to an account of the cleaner; and
c) said online merchant crediting a commission to an account of the online linker upon the confirmation receipt.

18. The method of claim 10, wherein the dispatching of the pressed apparels to the online shopper is implemented either by the cleaner's delivery or by the online shopper's pickup.

19. A method for networking an apparel purchasing with an apparel cleaning by use of a merchant server, a cleaner server, and a merchant agent server, comprising the steps of:
a) establishing an online merchant module in the merchant server, an online cleaner module in the cleaner server, and a merchant agent module in the agent server;
b) said respective modules cryptographically communicating with each other via an online merchant interface supervised by an online merchant, a cleaner interface supervised by a cleaner, and a merchant agent interface supervised by a merchant agent, wherein said respective interfaces are correspondingly coupled to said respective modules through a network, wherein an online shopper interface administered by an online shopper is linked to the network;
c) said merchant agent interface providing a click-through link from a first website supervised by the merchant agent module to a second website supervised by the online merchant module;
d) said online merchant dispatching to the cleaner one or more apparels ordered on the second website for the apparel purchasing and cleaning by the online shopper, in accordance with an order information on the online merchant interface linked to the second website; and
e) said cleaner pressing the apparels dispatched from the online merchant and dispatching the pressed apparels to the online shopper by either the cleaner's delivery or the online shopper's pickup.

20. The method of claim 19, wherein the second website includes a selectable apparel list, a selectable cleaner list, and a payment determiner.

21. The method of claim 20, wherein the payment determiner cryptographically determines a credit card payment.

22. The method of claim 19, further comprising, between the step c) and the step d), the steps of:
a) enabling said shopper to choose one or more apparels for purchase and selecting a cleaner for pressing the chosen apparels, respectively from the second website; and
b) enabling said shopper to make an online payment for the chosen apparels and for the apparels cleaning at the selected cleaner, respectively from the second website.

23. The method of claim 19, further comprising, after the step e), a step of said apparel cleaner receiving a cleaner charge from the shopper.

24. The method of claim 19, further comprising, after the step e), the steps of:
a) said cleaner sending to the online merchant a confirmation of the pressed apparel receipt by the online shopper;
b) said online merchant crediting a cleaning charge to an account of the cleaner; and
c) said online merchant crediting a commission to an account of the agent upon the confirmation receipt.

25. The method of claim 19, wherein the step d) comprises substeps of:
a) washing the apparels from the online merchant;
b) drying the washed apparels; and
c) ironing the dried apparels.

26. The method of claim 25, further comprising a step of bagging the ironed apparels either on hanger or in box.

27. The method of claim 19, wherein the network is a wide area network.
